(19) United States
(12) Patent Application Publication
(10) Pub. No.: US 2021/0371169 A1
(43) Pub. Date: Dec. 2, 2021

(54) BOWL AND LID SET

(71) Applicant: Yu-Hsiang CHEN, Tainan City (TW)

(72) Inventor: Yu-Hsiang CHEN, Tainan City (TW)

(21) Appl. No.: 17/131,257

(22) Filed: Dec. 22, 2020

(30) Foreign Application Priority Data
May 27, 2020 (TW) 109206557

(51) Int. Cl. B65D 43/02; A47G 19/02

(52) U.S. Cl. CPC B65D 43/0218; A47G 19/02; B65D 2543/00555; B65D 2543/005; B65D 2543/00537; B65D 2543/00092

(57) ABSTRACT

A bowl and lid set includes a lid member that has a top lid wall and a first surrounding wall extending downwardly from the top lid wall, and a bowl member that includes a bottom wall and a side wall extending upwardly from a periphery of the bottom wall. The side wall has an upper engaging portion that is made of an elastic material and that is deformable from a non-deformed state, where the bowl member is disengaged from the lid member and where a minimum inner diameter of the upper engaging portion is smaller than a maximum outer diameter of the first surrounding wall of the lid member, to a deformed state, where the upper engaging portion is resiliently stretched for tightly encircling the first surrounding wall.

### CROSS-REFERENCE TO RELATED APPLICATION

This application claims priority to Taiwanese Utility Model Patent Application No. 109206557, filed on May 27, 2020.

### FIELD

The disclosure relates to a tableware, and more particularly to a bowl and lid set.

### BACKGROUND

A conventional bowl with lid as shown in FIG. 1 includes a bowl 11 and a lid 12 openably disposed onto the bowl 11. Inmost cases, the bowl 11 is made of plastic, ceramics or stainless steel, while the lid 12 is made of plastic. However, though the lid 12 is able to cover the rim of the bowl 11 to prevent food contained therein from being contacted by dust, both the bowl 11 and the lid 12 are made of hard materials, and thus it is practically unworkable for the bowl 11 and the lid 12 to resiliently stretch and engage each other to achieve a complete sealing therebetween. Leaks may occur at times from an intersection between the bowl 11 and the lid 12.

### SUMMARY

Therefore, an object of the disclosure is to provide a bowl and lid set that can alleviate at least one of the drawbacks of the prior art.

According to the disclosure, the bowl and lid set includes a lid member and a bowl member. The lid member includes a top lid wall, and a first surrounding wall that extends downwardly from the top lid wall.

The bowl member includes a bottom wall, and a side wall that extends upwardly from a periphery of the bottom wall. The side wall has an upper engaging portion that is made of an elastic material, that is distal from the bottom wall, and that defines a rim opening.

The upper engaging portion of the side wall of the bowl member is deformable from a non-deformed state, where the bowl member is disengaged from the lid member and where a minimum inner diameter of the upper engaging portion is smaller than a maximum outer diameter of the first surrounding wall of the lid member, to a deformed state, where the upper engaging portion is resiliently stretched for tightly encircling the first surrounding wall.

### BRIEF DESCRIPTION OF THE DRAWINGS

Other features and advantages of the disclosure will become apparent in the following detailed description of the embodiment (s) with reference to the accompanying drawings, of which:

FIG. 1 is an exploded perspective view illustrating a conventional bowl with lid;

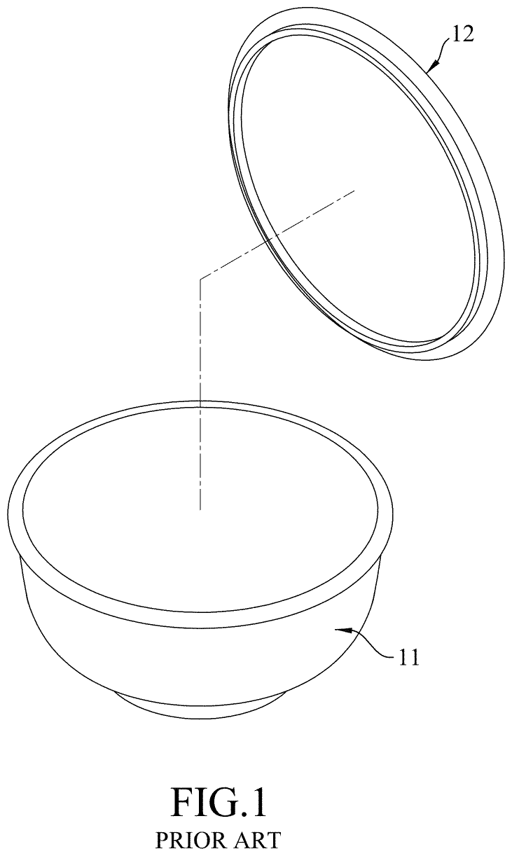

FIG. 2 is an exploded perspective view illustrating an embodiment of a bowl and lid set according to the present disclosure;

FIG. 3 is an exploded sectional view illustrating a bowl member and a lid member of the embodiment being separated from each other with an upper engaging portion of the bowl member being in a non-deformed state;

FIG. 4 is a fragmentary, enlarged exploded sectional view illustrating the upper engaging portion in the non-deformed state;

FIG. 5 is an assembled sectional view illustrating the bowl member and the lid member being coupled together with the upper engaging portion of the bowl member in a deformed state; and

FIG. 6 is a fragmentary, enlarged assembled sectional view illustrating the upper engaging portion in the deformed state.

### DETAILED DESCRIPTION

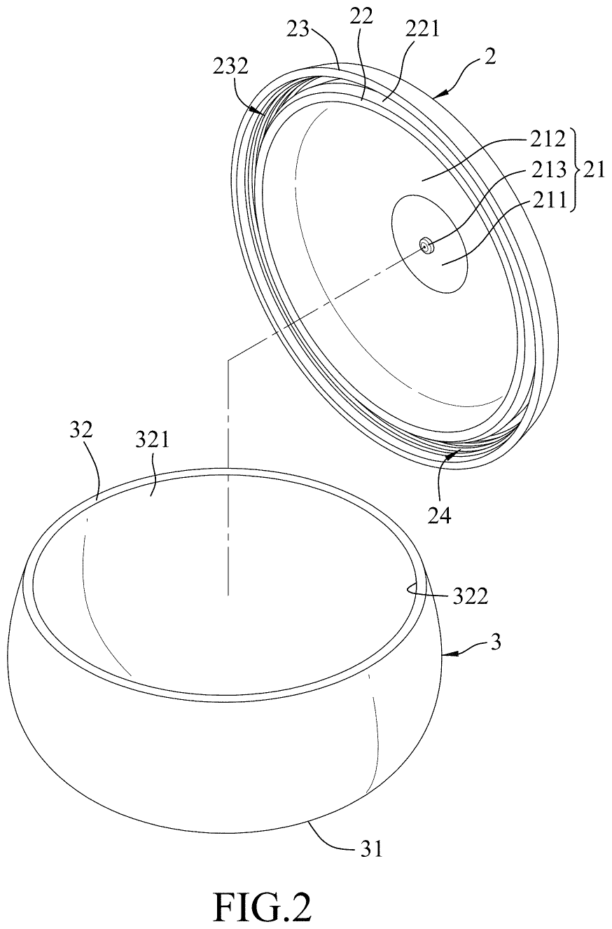

Referring to FIGS. 2 to 4, an embodiment of a bowl and lid set according to the disclosure includes a lid member 2 and a bowl member 3 that are made of silicone rubber having a Shore 80 hardness when measured by a Shore Durometer. In other embodiments of the disclosure, the lid member 2 and the bowl member 3 may be made of silicon rubber that has a Shore Durometer hardness ranging from 60 to 95.

The lid member 2 includes a top lid wall 21, a first surrounding wall 22 that extends downwardly from the top lid wall 21, and a second surrounding wall 23 that extends downwardly from the top lid wall 21 and that surrounds the first surrounding wall 22.

The top lid wall 21 has a first wall portion 211, a second wall portion 212, and a protruding segment 213. The first wall portion 211 is located at a medial part of the top lid wall 21, is in an annular shape, and is slightly downwardly indented. The second wall portion 212 is in a ring shape, and extends radially and slightly downwardly from the first wall portion 211. The protruding segment 213 is located at a medial part of a bottom surface of the first wall portion 211. The protruding segment 213 further has a central cavity 214 that extends through the protruding segment 213 and the first wall portion 211.

The first surrounding wall 22 has an annular surrounding wall surface 221 that faces outwardly toward the second surrounding wall 23. The surrounding wall surface 221 has a first surface portion 222 having a diameter that increases downwardly, and a second surface portion 223 connected to a lower end of the first surface portion 222 and having a diameter that decreases downwardly. The first surface portion 222 and the second surface portion 223 cooperatively define a protruding edge 224 at an intersection thereof.

The second surrounding wall 23 extends downwardly from an outer edge of the second wall portion 212 of the top lid wall 21, and cooperates with the first surrounding wall 22 to define an engagement groove 24 opening downwardly. In this embodiment, the second surrounding wall 23 has a plurality of inner protruding rings 232 protruding into the engagement groove 24 and being vertically spaced apart from each other.

The engagement groove 24 has a first groove portion 241 that extends between the second surrounding wall 23 and the first surface portion 222 of the surrounding wall surface 221 of the first surrounding wall 22, and a second groove portion 242 that is in communication with the first groove portion 241 and that extends downwardly from the first groove portion 241. A width of the second groove portion 242 between the first and second surrounding walls 22, 23 increases downwardly.

The bowl member 3 includes a bottom wall 31 and a side wall 32 extending upwardly from a periphery of the bottom wall 31. The side wall 32 has an upper engaging portion that is made of an elastic material, that is distal from the bottom wall 31, and that defines a rim opening 322. The upper engaging portion 321 of the side wall 32 of the bowl member 3 is used to engage the first groove portion 241 of the engagement groove 24 of the lid member 2 through the second groove portion 242 of the engagement groove 24.

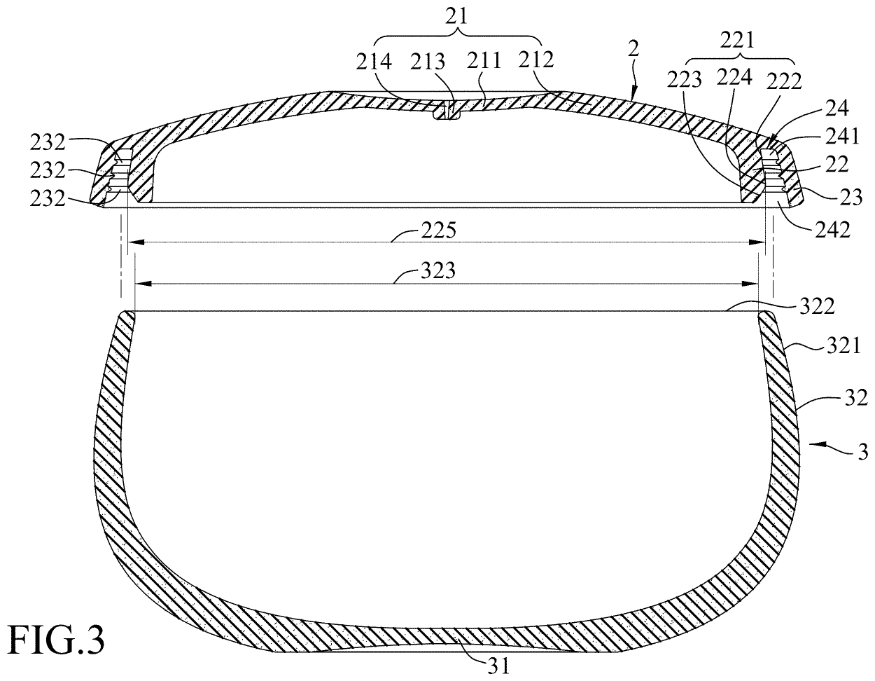

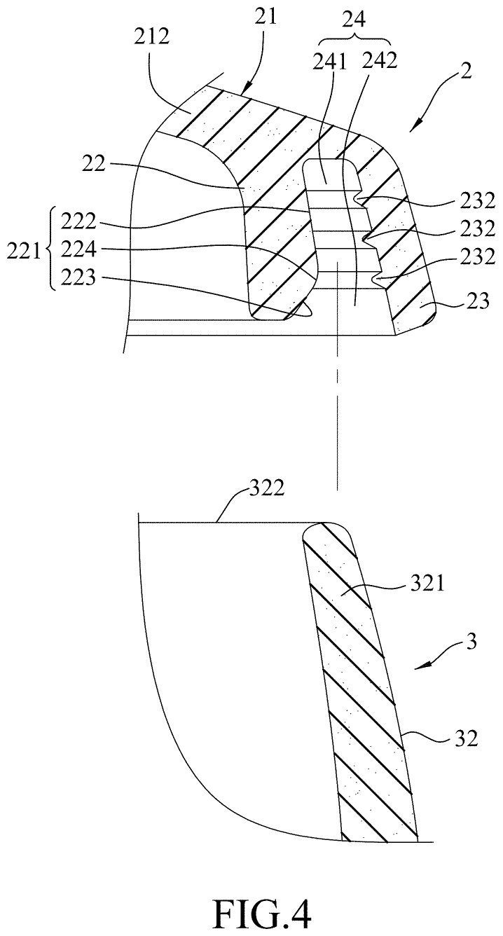

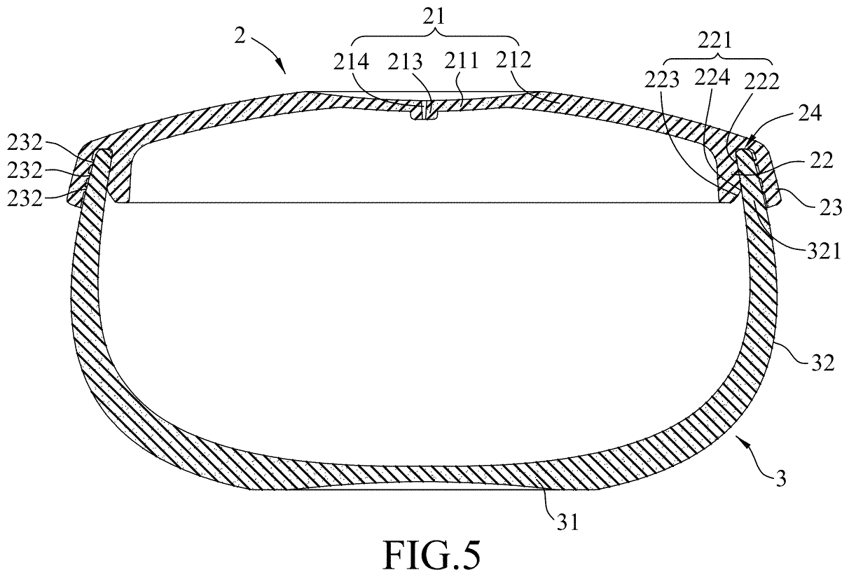

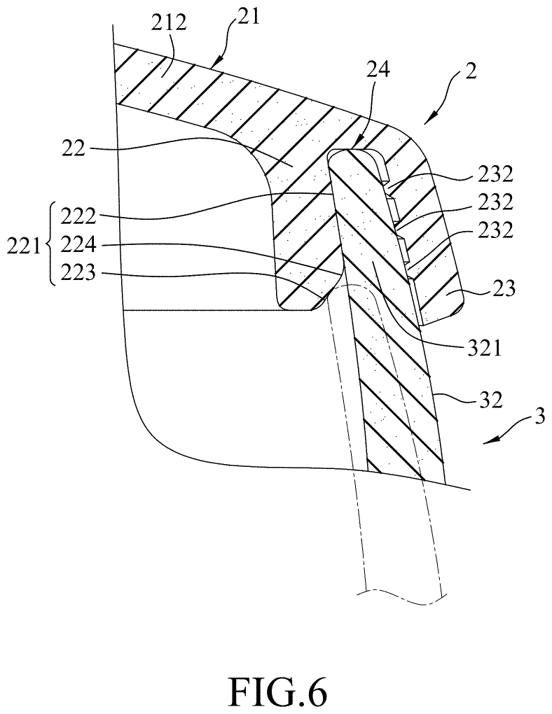

Referring to FIGS. 3 to 6, the upper engaging portion 321 of the side wall 32 of the bowl member 3 is deformable from a non-deformed state, as shown in FIGS. 3 and 4, to a deformed state, as shown in FIGS. 5 and 6. When the upper engaging portion 321 is in the non-deformed state, the bowl member 3 is disengaged from the lid member 2, and a minimum inner diameter 323 of the upper engaging portion 321, which is also the diameter of the rim opening 322, is smaller than a maximum outer diameter 225 of the first surrounding wall 22 of the lid member 2, which is also the diameter of the protruding ridge 224 of the first surrounding wall 22 (see FIG. 3). In the deformed state, the upper engaging portion 321 is resiliently stretched for tightly encircling the first surrounding wall 22. In use, during the process of coupling the lid member 2 to the bowl member 3, the upper engaging portion 321 of the side wall 32 of the bowl member 3 is inserted into the engagement groove 24 via the second groove portion 242, and is then resiliently stretched by the first surrounding wall 22 of the lid member 2 to the deformed state so as to be further inserted into the first groove portion 241 of of the engagement groove 24. Since the minimum inner diameter 323 of the upper engaging portion 321 of the bowl member 3 is smaller than the maximum outer diameter 225 of the first surrounding wall 22 of the lid member 2, and since the upper engaging portion 321 is made of an elastic material, the deformed state of the upper engaging portion 321 will enable a complete sealing engagement between the second surface portion 222 of the surrounding wall surface 221 of the first surrounding wall 22 of the lid member 2 and upper engaging portion 321 of the side wall 32 of the bowl member 3 to prevent potential leakage.

In this embodiment, the upper engaging portion 321 of the side wall 32 of the bowl member 3 extends upwardly and is inclined inwardly. As such, when the bowl and lid set of this embodiment is shaken substantially, liquid inside the bowl member 3 may experience up-and-down fluctuation, but the liquid will flow back down to an internal space of the bowl member 3 along the upper engaging portion 321. Such configuration also facilitates prevention of leakage between the lid member 2 and the bowl member 3.

When the upper engaging portion 321 is resiliently stretched and engages the first groove portion 241 of the engagement groove 24, the upper engaging portion 321 simultaneously and tightly abuts against the inner protruding rings 232 of the second surrounding wall 23 of the lid member 2, so that the inner protruding rings 232 resiliently deform (see FIG. 6) to form a barrier to prevent leakage.

Referring to FIG. 6, the second surface portion 223 of the surrounding wall surface 221 of the first surrounding wall 22 extends substantially inwardly from the lower end of the first surface portion 222, and provides a guiding surface for the upper engaging portion 321 of the side wall 32 of the bowl member 3 to engage the engagement groove 24. That is to say, the second surface portion 223 simplifies the effort for the sealing engagement between the lid member 2 and the bowl member 3, even though the minimum inner diameter 323 of the upper engaging portion 321 of the side wall 32 of the bowl member 3 is smaller than the maximum outer diameter 225 of the first surrounding wall 22 of the lid member 2.

By virtue of the differences between the minimum inner diameter 323 and the maximum outer diameter 225 and the deformable design of the upper engaging portion 321, the bowl and lid set in this embodiment significantly achieves leakage prevention when the upper engaging portion 321 engages the engagement groove 24 of the lid member 2.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiments, it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A bowl and lid set comprising:
a lid member that includes a top lid wall, and a first surrounding wall extending downwardly from said top lid wall; and
a bowl member that includes a bottom wall and a side wall extending upwardly from a periphery of said bottom wall, said side wall having an upper engaging portion that is made of an elastic material, that is distal from said bottom wall, and that defines a rim opening;
wherein said upper engaging portion of said side wall of said bowl member is deformable from a non-deformed state, where said bowl member is disengaged from said lid member and where a minimum inner diameter of said upper engaging portion is smaller than a maximum outer diameter of said first surrounding wall of said lid member, to a deformed state, where said upper engaging portion is resiliently stretched for tightly encircling said first surrounding wall.

2. The bowl and lid set as claimed in claim 1, wherein:
said first surrounding wall has an annular surrounding wall surface that faces outwardly, and that has a first surface portion having a diameter that increases downwardly, and a second surface portion connected to a lower end of said first surface portion and having a diameter that decreases downwardly, said first and second surface portions cooperatively defining a protruding edge at an intersection thereof; and
a diameter of said protruding ridge is the maximum outer diameter of said first surrounding wall of said lid member.

3. The bowl and lid set as claimed in claim 1, wherein said lid member further includes a second surrounding wall that extends downwardly from said top lid wall, that surrounds said first surrounding wall, that cooperates with said first surrounding wall to define an engagement groove opening downwardly, and that has at least one inner protruding ring protruding into said engagement groove.

4. The bowl and lid set as claimed in claim 3, wherein said at least one inner protruding ring includes a plurality of inner protruding rings that are vertically spaced apart from each other.

5. The bowl and lid set as claimed in claims 1, wherein:
said first surrounding wall has an annular surrounding wall surface that faces outwardly, and that has a first surface portion having a diameter that increases downwardly;
said lid member further includes a second surrounding wall that extends downwardly from said top lid wall, that surrounds said first surrounding wall, that cooperates with said first surrounding wall to define an engagement groove therebetween opening downwardly;
said engagement groove has a first groove portion that extends between said second surrounding wall and said first surface portion of said surrounding wall surface of said first surrounding wall; and
said upper engaging portion of said side wall of said bowl member engages said first groove portion of said engagement groove of said lid member and tightly encircles said first surface portion of said surrounding wall surface of said first surrounding wall in the deformed state.

6. The bowl and lid set as claimed in claim 5, wherein said engagement groove further has a second groove portion that is in communication with said first groove portion, and that extends downwardly from said first groove portion, a width of said second groove portion between said first and second surrounding walls increasing downwardly.

7. The bowl and lid set as claimed in claim 1, wherein said lid member and said bowl member are made of silicon rubber that has a Shore Durometer hardness ranging from 60 to 95.
